(19) United States
(12) Patent Application Publication
(10) Pub. No.: US 2011/0046124 A1
(43) Pub. Date: Feb. 24, 2011

(54) Bait Spray for Controlling Ant Populations

(76) Inventors: Rudolf H. Scheffran, Plantation, FL (US); Jack Richard Warner, Boca Raton, FL (US)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/922,796

(22) PCT Filed: Aug. 31, 2009
(86) PCT No.: PCT/US09/55526

§ 371 Date: Nov. 12, 2010

Related U.S. Application Data
(63) Continuation of application No. 61/093,147, filed on Aug. 29, 2008.

(51) Int. Cl. A01N 43/88; A01N 43/40; A01N 43/56; A01N 43/78; A01P 7/04; A01N 37/34

(52) U.S. Cl. 514/229.2; 514/341; 514/407; 514/357; 514/365; 514/522

(57) ABSTRACT

The subject invention provides spray formulations, and methods of use, for controlling ant populations.

### BACKGROUND OF THE INVENTION

Ants are common pests in and around the home as well as in agricultural settings. Certain ant species pose significant problems in the home, including damage to wooden structures, roofs, and electrical equipment. Ant pests have also been known to introduce contamination and disease by spreading pathogens, and some ant species inflict painful stings that can be life-threatening to sensitive individuals. In agriculture, some ants feed on geminating seeds and crop seedlings while some domesticate and protect other pest insects that feed on crops. Examples of pest ants include fire ants (Solenopsis spp.), argentine ants (Linepithema humile), pharaoh ants (Monomorium pharaonis), little black ants (Monomorium spp.), carpenter ants (Camponotus spp.), ghost ants (Tapinoma spp.), big-headed ants (Pheidole spp.) and white-footed ants (Technomyrmex albipes).

The white-footed ant was first collected from Indonesia, but has spread throughout the tropics and subtropical areas and is now found in Asia, Papua New Guinea, Guam, Australia, New Zealand, South Africa, Hawaii, and Florida. In recent years, reports of these ants infesting homes have increased considerably. These small ants exist in vast colonies, with colony size estimates ranging from 400,000 to over 1 million individuals. Due to their numbers and colonizing habits, these ants have become a nuisance to homeowners, and in some locations, these ants contribute to degradation of agricultural crops by protecting and nurturing insect pests, such as aphids and scales that feed on the crops.

Several biological aspects of the white-footed ant make it a difficult pest to control, including the size of colonies, tremendous reproduction capabilities, and tiny body size allowing entry to most structures. The potential exists for the migration of these pests into previously uninhabited areas.

To control insect pests, formulations including both a bait (attractant) and an insect toxicant are generally employed. Most commercially available baits contain either a vegetable oil or a sugar as the attractant. Although various insect pest baits are currently available, the utility of these baits for the control of sugar-loving ants has been limited. Many species of ants have proven to be difficult to control with currently available baits, as the ants do not feed on the baits for sufficient periods of time, and the components of the baits degrade rather rapidly.

One of the biggest challenges pest control operators have with pest ants is to achieve adequate control of hidden populations in structural voids and vegetation. The use of residual sprays to the exterior of buildings and/or the use of liquid or granular baits placed in numerous bait stations both inside and outside of structures has had minimal effect on these hidden populations, allowing them to continue to reproduce with a consequent rebound in populations.

A typical example of ant baiting is presented by Vega and Rust (2003), “Range and Reusrgence of Argentine Ant,” J. Econ. Entomol. Vol. 96, no. 3, pp. 844-849. The authors test both a residual insecticide barrier spray (no bait additive) and a liquid bait applied in bait stations.

U.S. Pat. No. 7,048,918 (incorporated herein in its entirety by reference) relates to a unique substance trademark NEC DEW that closely mimics natural food sources of various insects. Specifically, this substance mimics honeydews (produced by sucking insects) and nectars (from flowers and extrafloral nectaries—nectar-producing glands physically apart from the flowers). The '918 patent does not relate to sprayable formulations.

A 2008 article published in The Annual Review of Entomology reviews control practices of the Argentine ant (Linepithema humile Mayr) (Silverman & Brightwell, 2008). These authors indicate that the use of liquid ant baits has been restricted to containerized bait delivery. They state that “liquid bait appears to be an optimal delivery form” and describe its limitations.

“[Liquid baits] should be packaged in containers that restrict access to nontarget organisms, thereby limiting toxicant intake by humans, companion animals, and native fauna. This restriction effectively limits how much bait is applied, which could be far less than is required to eliminate or even reduce the ant population. Second, unless the product is adequately preserved, rapid microbial growth could diminish the bait's palatability. Third, water entering the container by precipitation or irrigation or leaving via evaporation could alter bait palatability by diluting or concentrating the sugar and toxicant. Finally, liquid spillage or leakage affects product performance.”

In their extensive review of the use of liquid baits, the concept of spraying a liquid bait is never mentioned. This is because it has never been studied and no literature exists describing such a practice.

The authors continue by describing many of the inadequacies observed over many years in pest ant control, both in the use of baits (both liquid and granular) and residual chemical spray practices, saying “no single treatment or control approach has been consistently effective.”

There is no known literature that suggests application of a liquid ant bait without the use of a bait station.

### BRIEF SUMMARY OF THE INVENTION

The subject invention provides spray formulations, and methods of use, for controlling ant populations. The use of the unique spray formulations causes a rapid, and lasting, reduction in ant populations.

In accordance with certain embodiments of the subject invention, tiny bait droplets applied to trailing sites on structures and infested vegetation quickly cause massive recruitment of other ants by forager ants. This mobilizes a large percentage of the ant population, which then feeds on the bait and becomes intoxicated. Advantageously, hidden populations are also affected and, ultimately, controlled by the sudden massive recruitment resulting from the use of the spray formulation of the subject invention.

### BRIEF DESCRIPTION OF THE DRAWINGS

FIG. 1 shows a test application of spray bait to base of trees.

FIG. 2 shows white-footed ants feeding on bait droplets.

FIG. 3 shows bait droplets on glass. Ants are able to crawl between the droplets.

FIG. 4 shows white-footed ants feeding near a window.

FIG. 5 shows white-footed ants feeding on bait droplets on an aluminum surface.

FIG. 6 shows rapid and massive recruitment of white-footed ants to bait sprayed on a wall.

FIG. 7 shows white-footed ants trail to spray bait from hidden nest sites in a roof.

FIG. 8 shows non-competitive simultaneous feeding of 2 ant species on spray bait: compact carpenter ants (larger ants) and white-footed ants.

FIG. 9 shows ghost ants feeding on spray bait.

FIG. 10 shows bi-colored trailing ants feeding on spray bait.

FIG. 11 shows day-old droplets on Ixora leaves. The droplets were still moist.

FIG. 12 shows total number of trailing white-footed ants crossing points in 15 seconds. The initial count was taken approximately 15 minutes before bait application.

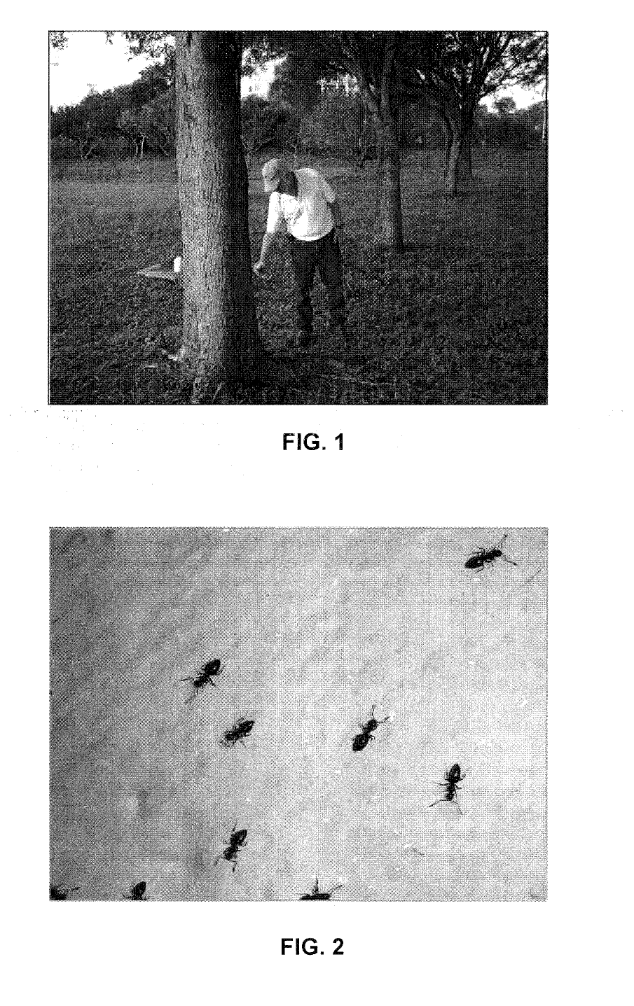

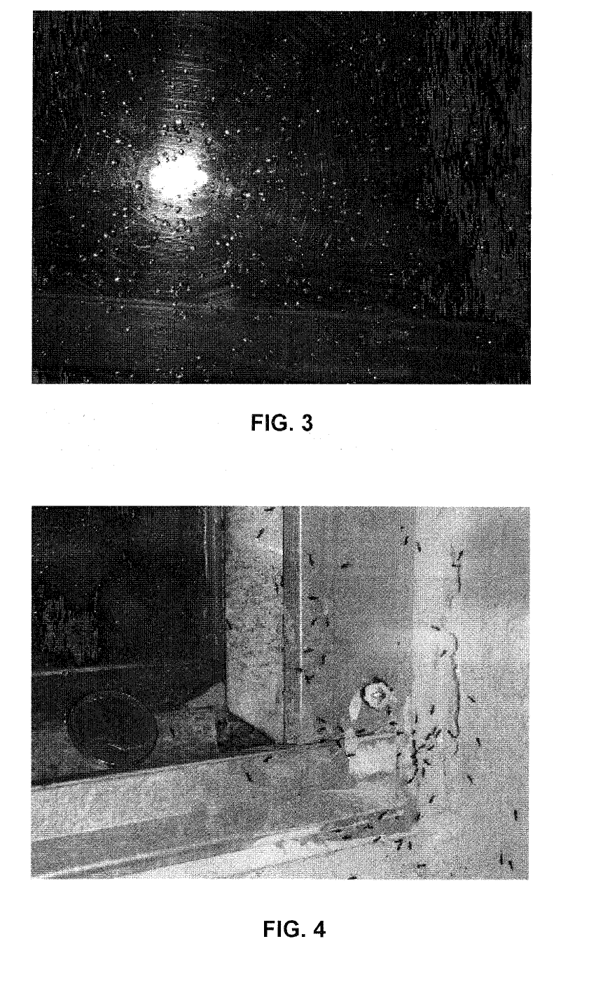

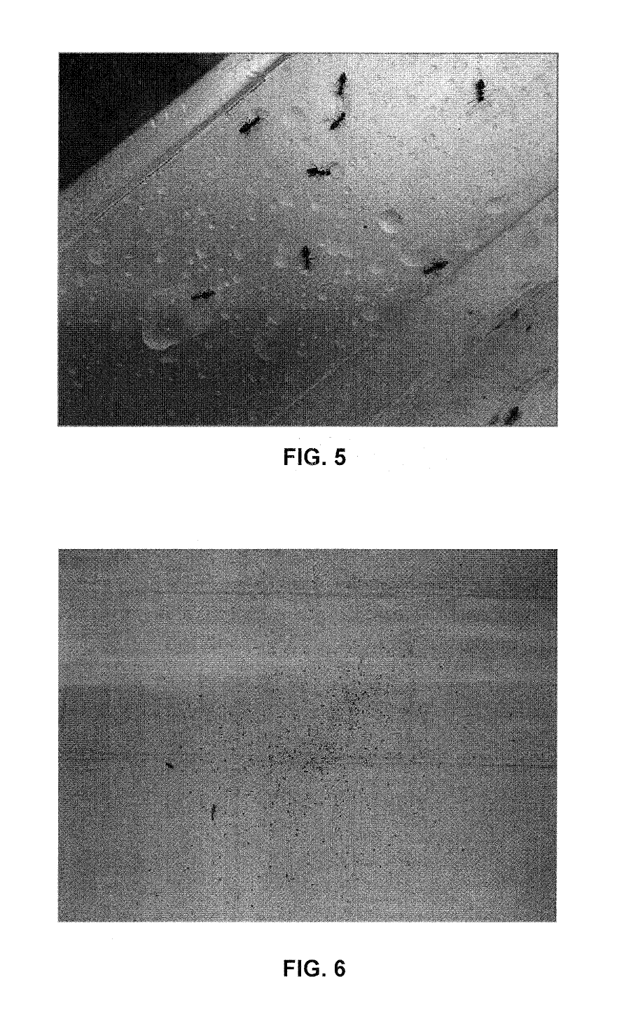

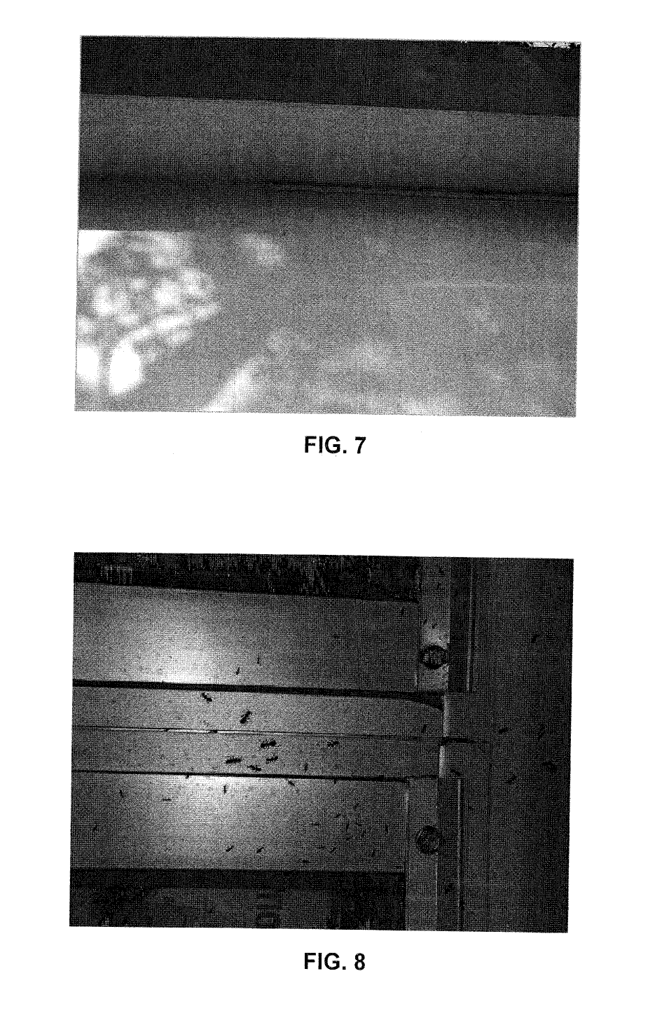

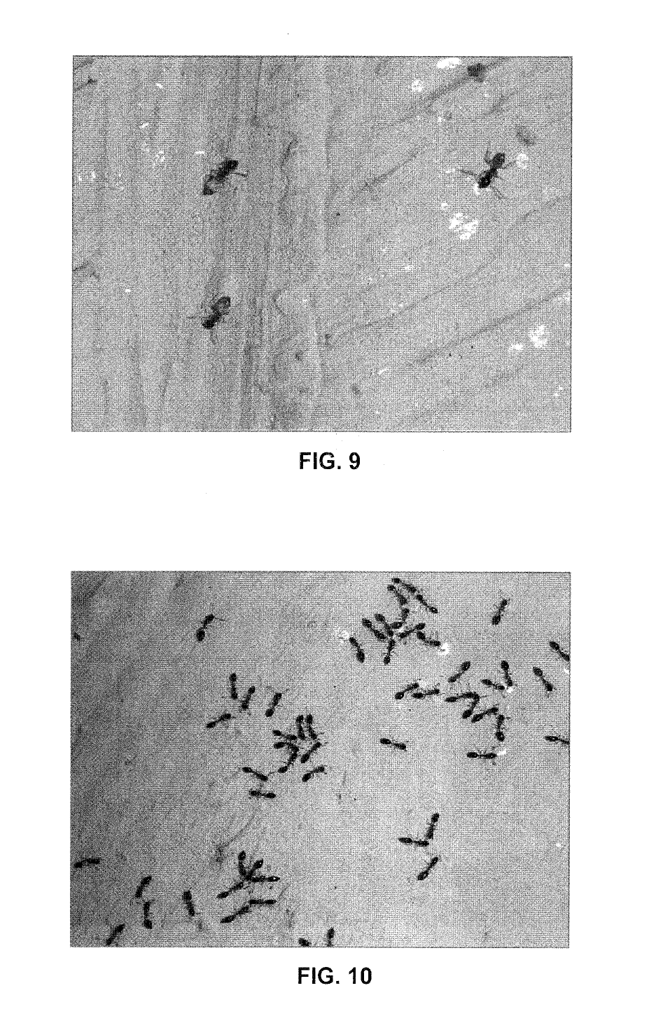

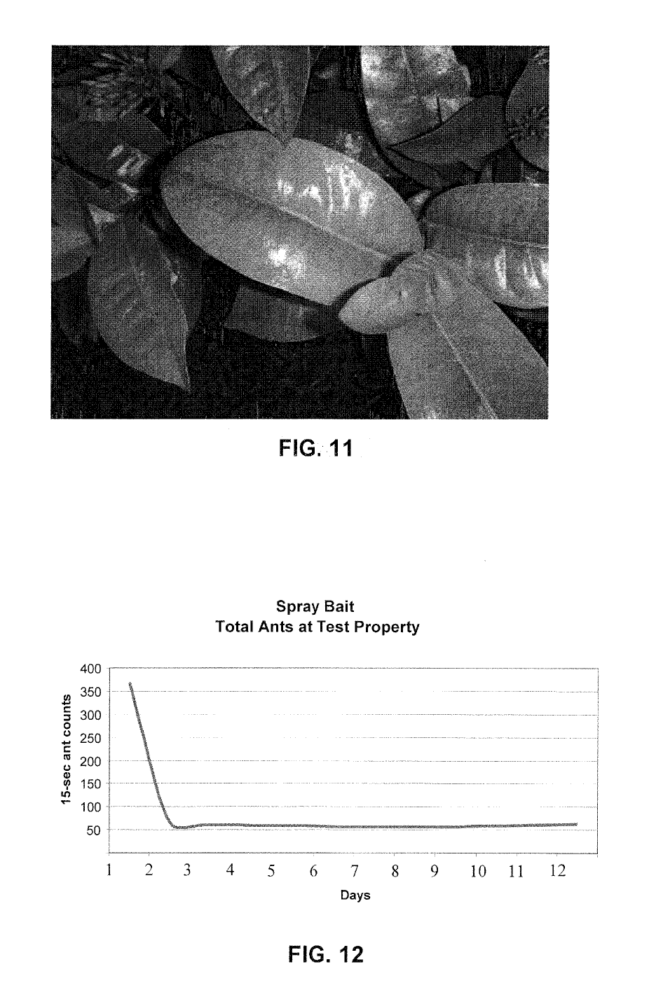

### DETAILED DISCLOSURE OF THE INVENTION

The subject invention provides spray formulations, and methods of use, for controlling ant populations. The use of the unique spray formulations causes a rapid, and lasting, reduction in ant populations.

As used herein, reference to “controlling” an ant population refers to reducing the number of ants compared to what that number would have been if the treatment was not administered.

The subject invention provides spray bait formulations. The formulation is typically, but not necessarily, applied to the lower exterior walls of a house and/or to surrounding vegetation. Small droplets applied by a coarse spray act as minute ant feeding stations. Foraging ants encounter the droplets very quickly because the droplets are in their immediate vicinity; then they recruit other ants to feed. Since a large number of foragers find the bait almost simultaneously, the recruitment effect is multiplied very rapidly, causing a high percentage of the entire population, including the “hidden populations” to feed on the bait.

Advantageously, use of this new formulation can result in significant population crashes in hours. Furthermore, the population remains low.

Spray droplets applied using this formulation and spray method resist drying by hygroscopically absorbing moisture from the air. Factors including both the droplet surface tension as well as spray pressure and droplet size produce a uniform, non-coalescing droplet pattern on surfaces that allows foraging ants to crawl between the droplets and feed on any droplet, without being entrapped by attractive forces on the liquid surface.

Due to the manner in which ants forage and feed, the droplet pattern used according to the subject invention is uniquely accessible to foraging ants, which immediately begin to feed on nearby droplets and then begin a process of recruiting nestmates. This recruiting is done by the foragers touching their abdomens to the surface and releasing a “recruitment pheromone” as they return to their nests. Ants in the nest sense the pheromones and follow the trail to the bait droplets, feed and then reinforce and augment the pheromone trails resulting in still more recruitment.

Nearby neighboring populations (off-site, i.e., the neighbor's property) are also affected and drawn to the feeding, which causes a decrease in those populations. This is beneficial because it is often those same off-site population that eventually re-infest the primary site.

Formulations of the subject invention can include NEC DEW ingredients as described in U.S. Pat. No. 7,048,918. Thus, the subject formulations can include a nectar-honeydew mimic that is very similar to the natural diet of most pest ants, greatly enhancing the recruiting effect and thereby the ultimate population control.

However, in the subject formulation, glycerin (or other additive(s)) is added to make the droplets hygroscopic, instead of drying out, they actually absorb water from the air and remain palatable to ants over an extended period. Also, in a preferred embodiment, corn syrup replaces the sugars in the NecDew formula to increase viscosity.

The spray bait of the subject invention is easily and quickly applied using a hand or backpack pressurized sprayer. Baiting without stations eliminates station and labor costs and tampering liability by children and pets. Other advantages of the subject formulations are that the pest control operator (PCO) is saved from the tedious efforts of filling and placing numerous bait stations that quickly become full of dead ants and mold, which then must be cleaned to be refilled. Residues are washed away by rains and sprinklers.

Using a water-compatible toxicant in the bait that is toxic to honeydew-producing insects has the added benefit of reducing the populations of honeydew-producing sucking insects found in vegetation, such as scales. Reducing the populations of these sucking insects eliminates a natural food (honeydew) source for ants as well as reducing sooty mold formation on leaves. The toxin that is toxic to honeydew-producing insects may be the same as, or different from, the ant toxin.

Food-grade additives (typically inexpensive) and very small quantities of active ingredient can be used in the practice of the subject invention because only minute amounts of active ingredients are required. Thus, there is little, if any, environmental impact.

In some preferred embodiments, a combination of the following elements can be present in the subject formulation:

1. a NecDew formulation;

2. an active ingredient (e.g., imidacloprid); and

3, a hygroscopic agent.

The compositions of the subject invention can “comprise,” consist of,” or “consist essentially of” the components recited herein. As used herein, the term “consists essentially of” means that there are no additional components that would materially effect the ability of the composition to control ants and retain the droplet characteristics achieved utilizing a hygroscopic agent as described herein.

Typical traits for an effective active ingredient in the NecDew Sprayable Bait include:

1. non-repellency (to ants);

2. slow-acting (preferably 12-24 hours mortality) at efficacious concentration; and

3. ant toxicity at concentration below residual use rate

The active ingredient (toxin) may be, for example, one or more of those shown in Table 1.

TABLE 1

| Active Ingredient | Supplier |
|---|---|
| thiamethoxam | Syngenta |
| imidacloprid | Bayer |
| fipronil | Bayer |
| acetamiprid | FMC |
| metaflumizone | BASF |
| indoxacarb | DuPont |
| clothidanidin | Valent |

All patents, patent applications, provisional applications, and publications referred to or cited herein are incorporated by reference in their entirety, including all figures and tables, to the extent they are not inconsistent with the explicit teachings of this specification.

We claim:

1. A method for controlling an ant population, comprising:
spraying a bait formulation on a location where ants forage, wherein said bait formulation comprises an agent that is toxic to ants and NEC DEW; and
wherein said bait formulation further comprises a hygroscopic agent.

2. The method, according to claim 1, wherein said hygroscopic agent is glycerin.

3. The method, according to claim 1, wherein said formulation comprises corn syrup.

4. The method, according to claim 1, wherein said bait formulation is sprayed using a hand or backpack pressurized sprayer.

5. The method, according to claim 1, wherein said agent that is toxic to ants is selected from the group consisting of thiamethoxam, imidacloprid, fipronil, acetamiprid, metaflumizone, indoxacarb, and clothidanidin.

6. The method, according to claim 1, wherein said spraying produces a small, uniform, non-coalescing droplet pattern.

7. The method, according to claim 1, wherein said bait formulation comprises an agent that is toxic to honeydew producing insects.

8. A spray formulation for controlling ant population, comprising
a NEC DEW formulation;
an agent that is toxic to ants; and
a hygroscopic agent.

9. The formulation, according to claim 8, wherein said hygroscopic agent is glycerin.

10. The formulation, according to claim 8, wherein said formulation comprises corn syrup.

11. The formulation, according to claim 8, wherein said agent that is toxic to ants is selected from the group consisting of thiamethoxam, imidacloprid, fipronil, acetamiprid, metaflumizone, indoxacarb, and clothidanidin.

12. The formulation, according to claim 8, wherein said bait formulation comprises an agent that is toxic to honeydew producing insects.
